(19) United States
(12) Patent Application Publication
(10) Pub. No.: US 2019/0353460 A1
(43) Pub. Date: Nov. 21, 2019

(54) TACTICAL ENGAGEMENT SIMULATION (TES) ACOUSTIC ROCKET AND MISSILE OFFENSIVE SUPPORT SYSTEM (ARMOSS)

(71) Applicant: Cubic Corporation, San Diego, CA (US)

(72) Inventors: Martyn Armstrong, Salisbury (GB); Neale Smiles, Salisbury (GB); Alastair Parkinson, Salisbury (GB); Jason Mayo, Medstead (GB)

(73) Assignee: Cubic Corporation, San Diego, CA (US)

(21) Appl. No.: 16/415,936

(22) Filed: May 17, 2019

Related U.S. Application Data
(60) Provisional application No. 62/673,316, filed on May 18, 2018.

(51) Int. Cl. F41G 7/00; G09B 9/00; G01H 9/00; G01H 1/00

(52) U.S. Cl. CPC F41G 7/006; G01H 1/00; G01H 9/008; G09B 9/003

(57) ABSTRACT

Embodiments disclosed herein address these and other issues by enabling rocket/missile artillery unit integration into the TES environment without the need to incorporate anything into the existing fire control system of the rocket/missile artillery units. Embodiments include a vibration sensor, orientation sensors, and a military communications unit, where the vibration sensor detects the vibrational signature of the “ARM” switch of the artillery unit and informs the military communications device that the launcher is “engaged.” The military communications unit can obtain orientation from the orientation sensors and pass engagement data (and orientation) to TES backend.

### CROSS-REFERENCES TO RELATED APPLICATIONS

This application claims the benefit of U.S. Provisional Patent Application No. 62/673,316, filed May 18, 2018, entitled “TES Acoustic Rocket And Missile Offensive Support System (TES ARMOSS),” which is assigned to the assignee hereof and incorporated by reference herein in its entirety.

### BACKGROUND

Embodiments of the invention(s) described herein are generally related to tactical engagement simulation (TES) for military training. That said, a person of ordinary skill in the art will understand that alternative embodiments may vary from the embodiments discussed herein, and alternative applications may exist.

In traditional TES training environments, the rocket and missile component of artillery Offensive Support (OS) plays little part in training for Combat Support operations. Particularly complex platforms such as Multiple Launch Rocket System (MLRS) and High-Mobility Artillery Rocket System (HIMARS) can provide battle-winning “first strike” capability, yet are rarely integrated with force-on-force training in a TES environment due to the complexities of the platform and the difficulty of integration with on-board fire control systems. Despite there being multiple nations fielding MLRS and HIMARS (with more nations fielding these systems in the future), there are few nations that are capable of using them during force-on-force training in a TES environment. This is primarily due to cost and complexity concerns.

### BRIEF SUMMARY

Embodiments disclosed herein address these and other issues by enabling rocket/missile artillery unit integration into the TES environment without the need to incorporate anything into the existing fire control system of the rocket/missile artillery units. Embodiments include a vibration sensor, orientation sensors, and a military communications unit, where the vibration sensor detects a vibrational signature of the “ARM” switch of the artillery unit and informs the military communications device that the launcher is “engaged.” The military communications unit can obtain orientation from the orientation sensors and pass engagement data (and orientation) to TES backend.

An example artillery unit simulation system, according to the description, comprises a vibration sensor configured to gather vibrational data of vibrations generated by the artillery unit, a launch module orientation sensor configured to obtain data regarding an orientation of a launch module of the artillery unit, a vehicle orientation sensor configured to obtain data regarding an orientation of a vehicle of the artillery unit, and a military communications unit configured to communicate wirelessly to a simulation backend and communicatively coupled with the vibration sensor, the launch module orientation sensor, and the vehicle orientation sensor. The military communications unit is configured to determine, from the vibrational data gathered by the vibration sensor, that a triggering vibrational signature generated by the artillery unit has been detected, and send, to the simulation backend, an indication of the detection of the triggering vibrational signature; an orientation of the launch module of the artillery unit, based on the data obtained by the launch module orientation sensor; and an orientation of the vehicle of the artillery unit, based on the data obtained by the vehicle orientation sensor.

Embodiments of the artillery unit simulation system may comprise one or more of the following features. The artillery unit may comprise a rocket or missile artillery unit. The military communications unit may be further configured to receive the vibrational data from the vibration sensor; and detect the triggering vibrational signature generated by the artillery unit from the vibrational data gathered by the vibration sensor. The vibration sensor may be further configured to detect the triggering vibrational signature generated by the artillery unit from the vibrational data, and provide an indication of the detection to the military communications unit. The military communications unit may be configured to send the indication of the orientation of the launch module of the artillery unit, the indication of the orientation of the vehicle of the artillery unit, or both, in response to determining that the triggering vibrational signature generated by the artillery unit has been detected. The military communications unit may be configured to send the indication of the orientation of the launch module of the artillery unit, the indication of the orientation of the vehicle of the artillery unit, or both, based on a predetermined schedule.

An example method of performing artillery unit simulation, according to the description, comprises obtaining, from one or more sensors vibrational data of vibrations generated by an artillery unit, data regarding an orientation of a launch module of the artillery unit, and data regarding an orientation of a vehicle of the artillery unit. The method further comprises determining, from the vibrational data, that a triggering vibrational signature generated by the artillery unit has been detected, and sending, to a simulation backend, an indication of the detection of the triggering vibrational signature; an orientation of the launch module of the artillery unit, based on the data regarding the orientation of a launch module; and an orientation of the vehicle of the artillery unit, based on the data regarding the orientation of the vehicle of the artillery unit.

Embodiments of the method may further comprise one or more the following features. The artillery unit may comprise a rocket or missile artillery unit. The method may further comprise receiving the vibrational data from a vibration sensor, wherein determining that the triggering vibrational signature generated by the artillery unit has been detected comprises detecting the triggering vibrational signature generated by the artillery unit from the vibrational data from the vibration sensor. The method may further comprise receiving the vibrational data from a vibration sensor, wherein determining that the triggering vibrational signature generated by the artillery unit has been detected comprises receiving, in the vibrational data, an indication that the triggering vibrational signature generated by the artillery unit has been detected by the vibration sensor. Sending the indication of the orientation of the launch module of the artillery unit, the indication of the orientation of the vehicle of the artillery unit, or both, may be in response to determining that the triggering vibrational signature generated by the artillery unit has been detected. Sending the indication of the orientation of the launch module of the artillery unit, the indication of the orientation of the vehicle of the artillery unit, or both, may be based on a predetermined schedule.

An example device for performing artillery unit simulation, according to the description, comprises a communication interface, a memory, and a processing unit communicatively coupled with the memory and the communication interface. The processing unit is configured to cause the device to obtain, from one or more sensors, vibrational data of vibrations generated by an artillery unit; data regarding an orientation of a launch module of the artillery unit; and data regarding an orientation of a vehicle of the artillery unit. The processing unit is further configured to cause the device to determine, from the vibrational data, that a triggering vibrational signature generated by the artillery unit has been detected; and send, to a simulation backend, an indication of the detection of the triggering vibrational signature; an orientation of the launch module of the artillery unit, based on the data regarding the orientation of a launch module; and an orientation of the vehicle of the artillery unit, based on the data regarding the orientation of the vehicle of the artillery unit.

Embodiments of the device may further comprise one or more the following features. The processing unit may be configured to obtain the vibrational data, the data regarding the orientation of the launch module, the data regarding the orientation of the vehicle, or any combination thereof, via the communication interface. The communication interface may comprise a wireless communication interface. The processing unit may be configured to cause the device to obtain the vibrational data at least in part by receiving the vibrational data from a vibration sensor, and the processing unit may be configured to cause the device to determine that the triggering vibrational signature generated by the artillery unit has been detected at least in part by detecting the triggering vibrational signature generated by the artillery unit from the vibrational data from the vibration sensor. The processing unit may be configured to cause the device to obtain the vibrational data at least in part by receiving the vibrational data from a vibration sensor, and the processing unit also may be configured to cause the device to determine that the triggering vibrational signature generated by the artillery unit has been detected at least in part by receiving, in the vibrational data, an indication that the triggering vibrational signature generated by the artillery unit has been detected by the vibration sensor. The processing unit may be configured to cause the device to send the indication of the orientation of the launch module of the artillery unit, the indication of the orientation of the vehicle of the artillery unit, or both, in response to determining that the triggering vibrational signature generated by the artillery unit has been detected. The processing unit may be configured to cause the device to send the indication of the orientation of the launch module of the artillery unit, the indication of the orientation of the vehicle of the artillery unit, or both, based on a predetermined schedule.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a simplified illustration of a TES environment, according to an embodiment;

FIG. 2 is a block diagram is a block diagram of various electrical components of a TES Acoustic Rocket And Missile Offensive Support System (ARMOSS), according to an embodiment;

FIG. 3 is a simplified block diagram of the internal components of a military communications unit (e.g., as illustrated in FIGS. 1-2), according to an embodiment; and

FIG. 4 is a flow diagram of a method of performing artillery unit simulation, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

Techniques described can utilize a cellular-based communications unit connected to one or more inertial measurement devices and a vibrationally-tuned trigger, in order to instrument a MLRS, HIMARS, or similar system for training in a TES environment. Systems for doing so may be referred to herein as TES Acoustic Rocket And Missile Offensive Support System (ARMOSS). Embodiments may further utilize open-architecture Distributed Interactive Simulation (DIS)/Higher Level Architecture (HLA) packet translator to then pass highly accurate and timely engagement data to the wider TES system using the cellular-based communications unit.

It can be noted that, although embodiments provided herein describe a communications unit using LTE Long Term Evolution (LTE) or other cellular technology, other wireless technologies can be used in addition or as an alternative to LTE/cellular to communicate with a wide area network (WAN) or other digital communication network. These technologies can include, for example, fifth-generation (5G) New Radio (NR) or Nth Generation (NG) wireless standards and protocols. A person of ordinary skill in the art will appreciate that such standards evolve, and that new equivalent standards may take their place.

It can be noted that, as used herein, the terms “sound,” “acoustic,” “audible,” and similar terminology may not be limited to sounds detectable by the human ear. Rather, these terms refer to physical vibrations that may be carried through various mediums (e.g., the air, the body of an artillery vehicle, and/or other mediums), and which may be detected using microphones and/or other sensors capable of detecting such vibrations. As used herein, the terms “vibrations” and “vibrational,” therefore, may include (among other frequencies), acoustic frequencies detectable by the human ear.

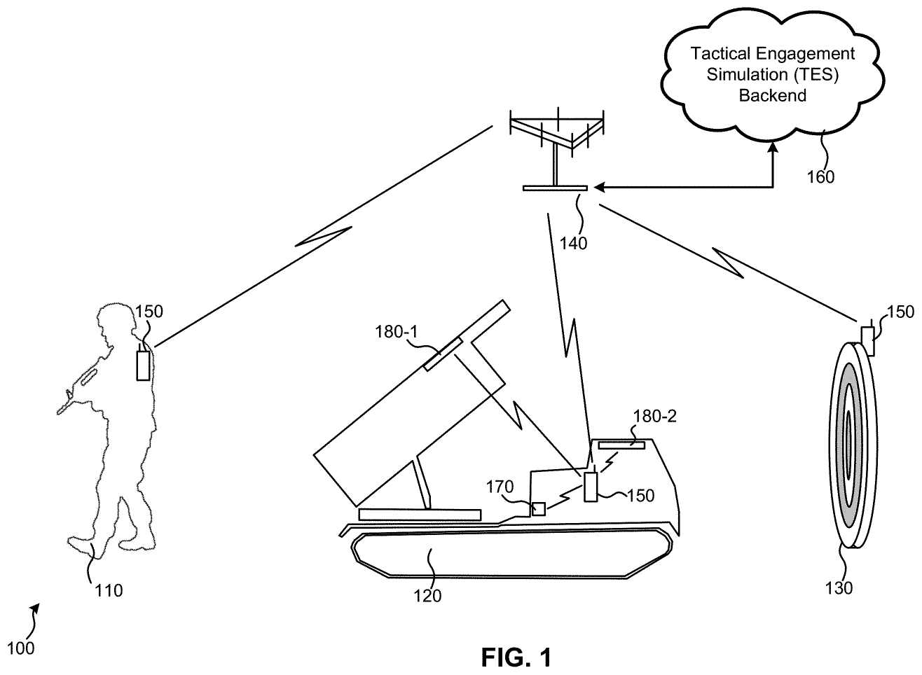

FIG. 1 is a simplified illustration of a TES environment 100, according to an embodiment. As discussed herein below, the TES environment 100 may be capable of providing training in a field exercise involving multiple types of entities, such as soldiers 110, rocket/missile artillery units 120 (e.g., MLRS, HIMARS, and/or similar systems), targets 130, and/or other entities, such as non-rocket/missile artillery, vehicles, weapons, equipment, buildings, etc. Rather than live ammunition, the training in the TES environment 100 may comprise a “dry” training in which laser transmitters (e.g., Multiple Integrated Laser Engagement System (MILES)) and/or other equipment is used to simulate the firing of weaponry. Moreover, the various entities in the TES environment 100 can communicate wirelessly via LTE (or similar wireless technology) to a base station 140, using a military communications unit 150. And the base station 140 can communicate between the various entities and a TES backend 160.

It can be noted that, to avoid clutter, FIG. 1 illustrates one soldier 110, rocket/missile artillery unit 120, and one target 130. However, a person of ordinary skill in the art will appreciate that training within a TES environment 100 may have any number of each entity type (including no entities of a certain type). For example, in a given training, the TES environment 100 may comprise dozens, hundreds, or even thousands (or more) of soldiers 110, rocket/missile artillery units 120, targets 130, and/or other entities. Moreover, embodiments additionally or alternatively may include any number of base stations 140.

In brief, each military entity 110, 120, and 130 may be provided with a military communications unit 150 capable of communicating with the TES backend 160 via a base station 140. As previously noted, wireless communication may utilize a high-bandwidth digital communication standards, such as LTE or other cellular technologies, thereby giving the military communication system a very high throughput capacity, relative to traditional techniques. (In the case of LTE, the base station 140 would comprise a eNodeB (eNB).) Moreover, utilization of LTE or similar technologies can enable the TES environment to utilize non-line-of-sight systems.

The TES backend 160 may comprise one or more computer servers configured to gather information from the various entities within the TES environment 100 and provide information regarding the training in real-time and/or post hoc in After-Action Review (AAR). The information gathered from the various entities within the TES environment 100 may include, for example, status information (e.g., whether the entity is “killed” or “injured”, location and/or orientation information, etc.), information specific to an entity type (e.g., remaining fuel/ammunition, whether a weapon or equipment is deployed/armed, etc.), engagement information (e.g., whether it has engaged and/or has been engaged by other entities), and the like. The information provided by the TES backend 160 may include any of a variety of analytics and/or visual simulations.

In some embodiments, for example, the TES backend may provide analytical information to simulation supervisors to determine whether individual entities performed as commanded, the effectiveness of overall strategies, how different entities may interact, and so forth. Again, this analytical information may be provided in real-time or post hoc.

In some embodiments, for example, the TES backend may provide a 3-D computer-simulated visualization of a “virtual” battlefield populated by 3-D visualizations of the various entities within the TES environment 100. In some embodiments, entities within the TES environment 100 may be provided with a simulated visualization of the virtual battlefield in real time. That is, soldiers 110 and/or other entities training in the TES environment 100 may be equipped with a display (e.g., capable of providing an augmented reality (AR), mixed reality (MR), virtual reality (VR), or a similar visualization) showing a visualization, which may be overlaid on a corresponding physical entity in the TES environment 100.

As previously noted, traditional TES training environments provide little with regard to rocket/missile artillery unit 120 training. This can be due to the fact that these are highly technical platforms. For example MLRS and HIMARS systems may have a fully computerized fire control system spread throughout several main Line Replaceable Units (LRUs) over a robust, secure, contained data bus. This means that any in-line instrumentation that would provide functionality in the TES environment 100 would need to be accredited with the design authority to permissibly “plug-in.” Thus, enabling such a rocket/missile artillery unit 120 to operate in a TES environment 100 in this manner can be expensive, violates principles of interfering with a previously virgin data-bus, and may introduce weaknesses in the protection of the system. Moreover, such solutions may be extremely expensive to implement.

Furthermore, where training involves live fire, rocket/missile artillery unit 120 training is again typically lacking. Often times, reduced-range practice rockets are used for live firing. These practice rockets are typically not guided, and decrease realism for tactical training considerably. They are also very expensive themselves, and may require separate logistics set up to provide this nonoperational resource. As such, rocket/missile artillery units 120 are rarely used at representative ranges in force-on-force training.

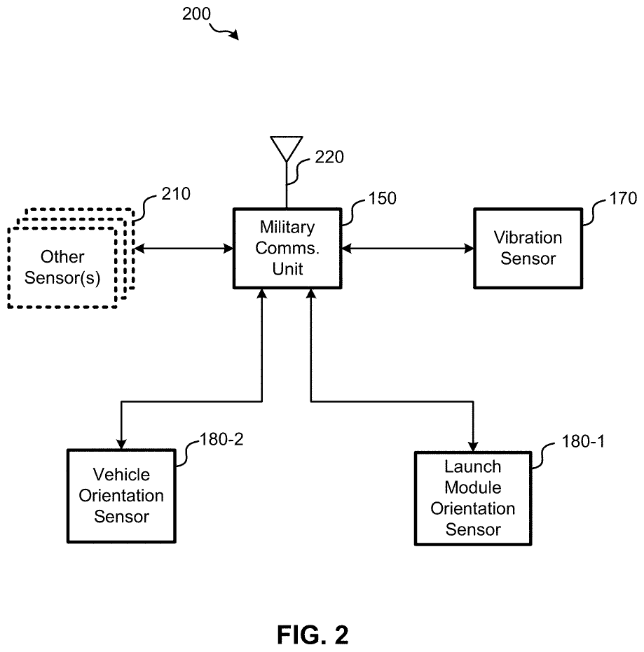

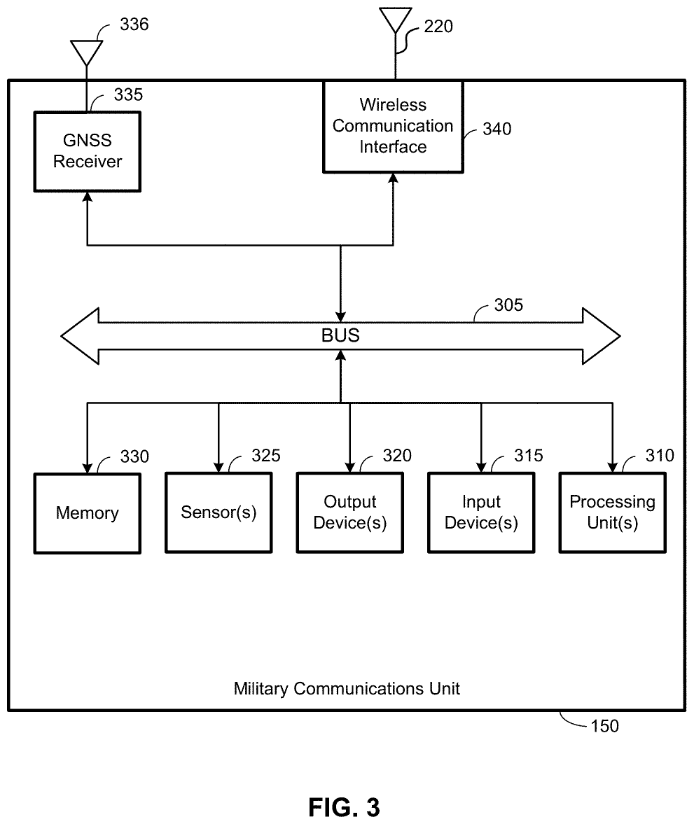

According to embodiments herein, rocket/missile artillery units 120 may be equipped with TES Acoustic Rocket and Missile Offensive Support System (TES ARMOSS), comprising devices that enable integration into the TES environment 100 without the need to incorporate anything into the existing fire control system of the rocket/missile artillery units 120. TES ARMOSS comprises a vibration sensor 170, orientation sensors 180-1 and 180-2 (collectively and generically referred to herein as orientation sensors 180), and a military communications unit 150. By leveraging-off the platform's immediate pre-firing vibrational signature, the vibration sensor 170 (e.g., a microphone or piezoelectric sensor) may simply “listen” for the increased vibrational signature of the servos locking-out when the “ARM” switch of the rocket/missile artillery unit 120 is activated and then inform the military communications device 150 that the launcher is “engaged.” The military communications unit 150 in turn can blend engagement with orientation (e.g., orientation of the launch module from the launch module orientation sensor 180-1 and optionally orientation of the rocket/missile artillery units 120 from the vehicle orientation sensor 180-2) and then pass engagement data to TES backend 160. “Duration” also can be measured. Additional details regarding TES ARMOSS are provided herein below with regard to FIGS. 2-3

It can be noted that TES ARMOSS not only may be utilized with the most technologically advanced rocket/missile artillery units 120 (MLRS and HIMARS) but may additionally or alternatively be used with multiple types of older platforms.

With these features, the TES ARMOSS as described herein can be seamlessly integrated into a TES environment 100, providing a number of advantages. These advantages may comprise one or more of the following:
a. Collective Training. Embodiments may provide for collective training in which rocket/missile artillery units 120 can be routinely involve and critically tested in force-on-force training. Land-Based Precision Fires are the force multiplier in many militaries, yet are rarely trained in the manner that they should be. By providing accurate engagement data from the platform in real time (e.g., over LTE) realistic ranges, effects, and consequences can be trained tactically.
b. Individual Training. The real strength of LBPF comes from well-trained crews, platoons and batteries. This system will provide non-intrusive assessment of the tactical readiness of MLRS, HIMARS and other systems' operators.
c. Cost. By having no direct interface with the platforms' data bus the system can be simple, discrete, reconfigurable and provide stretch/growth potential.
d. Accreditation. No safety case violations will take place, because there is no in-line connection.

FIG. 2 is a block diagram of various electrical components of a TES ARMOSS 200, according to an embodiment. Here, the components include a military communications (“comms.”) unit 150, and vibration sensor 170, a launch module orientation sensor 180-1, a vehicle orientation sensor 180-2, and (optionally) other sensor(s) 210. It can be noted that the components illustrated in FIG. 2 are provided as illustrative examples only. Embodiments may have additional or alternative components, may utilize any or all of the illustrated components or other types of components, may combine the functionality of various illustrated components (e.g., incorporate one or more sensors into the military comms unit 150), and/or may utilize multiple components of the same type (e.g., multiple vibration sensors 170), as needed in a TES environment 100.

Arrows illustrated in FIG. 2 represent communication and/or physical links between the various components. Communication links may use wireless and/or wired technologies. Wireless connections can include technologies such as Bluetooth®, Bluetooth Low Energy (BLE), Zigbee®, Wi-Fi®, near field communications (NFC), and/or other wireless technologies. To help ensure security communications, these wireless and/or wired communication links may use one or more types of encryption, which can be made to meet military-grade standards, if required.

The vibration sensor 170 may comprise a microphone, piezoelectric sensor (e.g., a ceramic piezoelectric sensor), and/or other sensor capable of detecting any of a wide range of vibrational frequencies generated by a rocket/missile artillery unit 120 on which some or all of the components of the TES ARMOSS 200 are mounted or otherwise coupled. More particularly, the vibration sensor 170 may be “tuned” to detect the distinguishable vibrational signature created by the rocket/missile artillery unit 120 when its weaponry is armed, including frequencies below or above those detectable by humans. As previously noted, the rocket/missile artillery units 120 generate a particularly unique vibrational signature (e.g., from servos locking out) when armed. The vibration sensor 170 can thereby be tuned to detect this triggering vibrational signature, from vibrations carried through the air and/or vibrations of the chassis of the rocket/missile artillery unit 120. In some embodiments, frequencies of the triggering vibrational signature can range from 1 Hz to 60 kHz, for example. When the triggering vibrational signature is detected, the vibration sensor 170 may then provide the military communications unit 150 with an indication that the triggering vibrational signature has been detected. The military communications unit 150 can, in turn, communicate with the TES backend 160 (e.g., via antenna 220), indicating the activation of the rocket/missile artillery unit 120. This activation be treated as a “firing” of the weapon when training in the TES environment 100.

One or more vibration sensors 170 may be used in any given embodiment, and the location of the vibration sensor(s) 170 with respect to the rocket/missile artillery unit 120 can vary, depending on factors such rocket/missile artillery unit, sensor type, etc. Frequently, a vibration sensor 170 would be located on or near the portion(s) of the rocket/missile artillery unit 120 generating the vibrations the vibration sensor 170 is intended to detect. However, vibrations may be sufficiently strong that it can be decoded at many locations on, in, or near the rocket/missile artillery unit 120. In some embodiments, for example, a vibration sensor 170 may be located at the bottom of the loss module. Additionally or alternatively, a vibration sensor 170 may be located at the top of the carrier bed (into which the launch module can rest when in transit). Additional or alternative locations may be used in alternative embodiments.

Embodiments may vary in how the vibrations are processed, depending on desired functionality. For instance, in some embodiments, the vibration sensor 170 may provide raw vibrational data to the military communications unit 150, in which case the military communications unit 150 may filter the raw vibrational data to detect the triggering vibrational signature. In other embodiments, the vibration sensor 170 may include processing circuitry and/or software to process the vibrational data and determine whether the triggering vibrational signature is present. In the latter case, the vibration sensor 170 can then provide an indication to the military communications unit 150 that the triggering vibrational signature has been detected.

The “tuning” of the TES ARMOSS 200 (using the vibration sensor 170 and/or military communications unit 150) to detect the triggering vibrational signature may be employed in any of a variety of ways. One or more software and/or hardware filters may be used to detect one or more frequencies of the triggering vibrational signature of a rocket/missile artillery unit 120. As such, embodiments may be tuned to listen for a particular frequency or a particular frequency envelope. In some embodiments, one or more frequencies of the triggering vibrational signature must exceed a particular amplitude threshold before the TES ARMOSS 200 determines the presence of the triggering vibrational signature. (This can help ensure, for example, that the TES ARMOSS 200 for a first rocket/missile artillery unit 120 does not indicate that a triggering vibrational signature has been detected when a second rocket/missile artillery unit 120 nearby is armed.) In some embodiments, the relative amplitude of some frequencies compared with other frequencies (e.g., a shape of a frequency envelope) may be utilized to further filter out false positives.

Additionally or alternatively, a TES ARMOSS 200 may be configured to detect triggering vibrational signatures of different types of rocket/missile artillery units 120. That is, because different types of rocket/missile artillery units 120 may generate different types of sounds or other vibrations when armed, the TES ARMOSS 200 may be tuned to detect to the triggering vibrational signatures of these different types of rocket/missile artillery units 120. In some embodiments, detection may be automatic. In other embodiments, a user may (e.g., via a user interface on the military communications unit 150 and/or a touchscreen display unit communicatively coupled therewith) select the type of rocket/missile artillery units 120 to which the TES ARMOSS 200 is coupled, causing the TES ARMOSS 200 to implement the frequency filter(s) and/or other processing for detecting the corresponding triggering vibrational signature of the selected rocket/missile artillery units 120.

The launch module orientation sensor 180-1 may comprise a sensor module incorporated into or otherwise coupled with the launch module of the rocket/missile artillery unit 120 in which the TES ARMOSS 200 is installed. (Because the launch module may have a different orientations relative to the rocket/missile artillery unit 120, information regarding the actual orientation of the launch module can be important for enabling the TES backend 160 to determine an area within a battlefield (which may include a target 130) at which the rocket/missile artillery unit 120 is aimed.) The launch module orientation sensor 180-1 may include one or more of a variety of orientation sensors, such as accelerometer (including and Inertial Measurement Unit (IMU)), gyroscope, magnetometer, altimeter, and/or the like. As such, the launch module orientation sensor 180-1 may be capable of providing information indicative of the location, heading, slope, azimuth, elevation, of the launch module of the of the rocket/missile artillery unit 120.

The data provided by the launch module orientation sensor 180-1 can vary, depending on desired functionality. Similar to the vibration sensor 170, the launch module orientation sensor 180-1 may provide raw data to the military communications unit 150 (from which the military communications unit 150 may determine the azimuth, elevation, etc. of the launch module) and/or may provide data derived from the raw data, such as the azimuth, elevation, etc. of the launch module.

In some embodiments, this data may be provided to the military communications unit 150 on-demand, when the military communications unit 150 requests the data. For example, when the TES ARMOSS 200 determines (using the military communications unit 150 and/or vibration sensor 170) that a triggering vibrational signature has been detected the rocket/missile artillery unit 120, the military communications unit 150 may request launch module orientation data from the launch module orientation sensor 180-1. The launch module orientation sensor 180-1 can then provide the requested launch module orientation data.

Additionally or alternatively, launch module orientation data provided by the launch module orientation sensor 180-1 may be sent to the military communications unit 150 automatically, based on a predetermined schedule, periodicity, triggering event (e.g., detected movement) etc. According to some embodiments, the predetermined schedule, periodicity, triggering event, etc. governing the automatic communication of the launch module orientation data to the military communications unit 150 may be user-defined.

The vehicle orientation sensor 180-2 may be similar to the launch module orientation sensor 180-1. As such, the vehicle orientation sensor 180-2 may comprise similar hardware and/or software, and may provide similar functionality to the launch module orientation sensor 180-1 as described above. As illustrated in FIG. 1, however, the vehicle orientation sensor 180-2 may be attached to the body of the vehicle, rather than the body of the launch module. Thus, the vehicle orientation sensor 180-to may provide orientation data regarding the vehicle of the rocket/missile artillery unit 120. Additionally or alternatively, the vehicle orientation sensor 180-to may provide the speed and/or heading of the vehicle. This separate orientation information may be helpful to the TES backend 160 in accurately re-creating a virtual battlefield based on entities in the TES environment 100 and/or in providing data for AAR. According to some embodiments, the military communications unit 150 may be configured to provide the TES backend 160 with periodic information regarding the vehicle orientation, speed, and/or location based on a GNSS receiver (which may be included in the military communications unit 150, as indicated below) and information from the vehicle orientation sensor 180-2, where additional information from the launch module orientation sensor 180-1 may be provided in response to a triggering event (e.g., the detection of a triggering vibrational signature based on vibrational data from the vibration sensor 170).

Optionally, the TES ARMOSS 200 may include one or more other sensors 210, depending on desired functionality. Here, the other sensors may include, for example, a GNSS receiver (in addition or as an alternative to the GNSS receiver of the military communications unit 150 illustrated in FIG. 3), an orientation unit coupled to another component of the rocket/missile artillery unit 120 or related auxiliary equipment, a camera, a laser detector (or other detector and/or transmitter capable of simulating engagement with other entities training in the TES environment 100), additional vibration sensors to detect mechanical vibrations or noises of any mechanical or electrical devices of the rocket/missile artillery unit 120, additional temperature monitoring sensors of any mechanical or electrical devices of the rocket/missile artillery unit 120, additional data interfaces to any electrical devices of the rocket/missile artillery unit 120.

The military communications unit 150 can provide computational/processing functionality for the TES ARMOSS 200 and further enable communications between the TES ARMOSS 200 and the other entities within the TES environment 100. In some embodiments, the functionality of the military communications unit 150 may be customized by executing different software applications. For example, the military communications unit 150 may operate using the Android™ operating system, thereby being able to execute any of a variety of software programs (or “apps”) executable for Android, which may include commercial and/or military applications. Some of these software programs may be customized for execution specifically by the military communications unit 150. (Moreover, as illustrated in FIG. 1, different military communications units 150 may be customized or different entities within a TES environment 100. Such customization may be enabled, for example, by executing different applications.) Other embodiments may utilize other types of operating systems, as desired. The military communications unit 150 may communicate via an antenna 280 using any of a variety of radio frequency (RF) technologies, such as LTE or other cellular technologies.

According to embodiments, the military communications unit 150 may coordinate the gathering of data from the vibration sensor 170, orientation sensors 180, and (optionally) other sensor(s) 210 and communicate them to the TES backend 160 in order to provide an accurate simulation of the training. For example, the military communications unit 150 may be configured to provide the TES backend 160 with information regarding the orientation of the rocket/missile artillery unit 120 vehicle and/or launch module, as well as an indication of when the rocket/missile artillery unit 120 fires a missile/rocket. The TES backend 160 can then use the orientation information of the launch module (which may be complemented by location information provided by a GNSS receiver in the military communications unit 150, launch module orientation sensor 180-1 itself, or elsewhere within the TES ARMOSS 200 as indicated herein) to determine where, in the training/simulated battlefield, the missile/rocket will land. If there is a target 130 or other entity within the kill/injure radius of the landing site, the TES backend 160 can communicate this information to the target 130 or other entity. (It can be noted that, although the missile/rocket may be guided, the information provided by the TES ARMOSS 200 (and more particularly by the military communications unit 150 of the TES ARMOSS 200) to the TES backend 160 may be sufficient for training and/or simulation purposes.)

As previously noted, communication between the military communications unit 150 and other entities within the TES environment 100 (e.g., the TES backend 160) may pass through a Wide Area Network (WAN), such as a cellular network. The WAN may comprise one or more private and/or public networks, military and/or commercial providers, and may utilize any of a variety of wireless and/or wired technologies.

FIG. 3 is a simplified block diagram of the internal components of a military communications unit 150 (e.g., as illustrated in FIGS. 1-2), according to an embodiment. As with other figures provided herein, it will be understood that alternative embodiments may comprise alternative configurations of the components, and may add, omit, combine, separate, and/or otherwise alter components, depending on desired functionality. The military communications unit 150 may comprise a military design meeting military-grade standards, thereby configured to withstand higher levels of physical impacts, temperature extremes, and/or other environmental hazards than a consumer device. Nonetheless, a consumer-grade design and/or design met to meet other standards may be used if so desired. It will be understood that the military communications unit 150 may comprise other electrical components (e.g., a battery or other power source) not illustrated in FIG. 3.

The various hardware components (components labeled 310-340) of the military communications unit 150 can be electrically coupled via a bus 305 (or may otherwise be in communication, as appropriate). The hardware elements may include a processing unit(s) 310 which may comprise without limitation one or more general-purpose processors, one or more special-purpose processors (e.g., application specific integrated circuits (ASICs), and/or the like), reprogrammable circuitry, and/or other processing structure or means, which can be configured to cause the military communications unit 150 to perform the functionality described herein. The military communications unit 150 also may comprise one or more input devices 315, which may comprise without limitation one or more touch screens, touch pads, buttons, dials, switches, and/or the like; and one or more output devices 320, which may comprise without limitation, one or more displays, light emitting diode (LED)s, speakers, and/or the like. The input device(s) 315 and/or output device(s) 320 may provide, for example, a user interface enabling a user to alter settings and/or otherwise customize the functionality of the TES ARMOSS 200. (Alternatively, the military communications unit 150 may communicate with a separate device (e.g., a smart phone, tablet, etc.) via the wireless communication interface 340 to provide a user interface.) In military applications, the input device(s) 315 and/or output device(s) 320 may be limited, in comparison with consumer devices such as smartphones. For example, in some embodiments, input device(s) 315 may be limited to a power switch and navigation buttons, and output device(s) 320 may be limited to a small, low power display. In some embodiments, the military communications unit 150 may comprise a Universal Serial Bus (USB) port for data communication and/or battery charging.

In some embodiments, the military communications unit 150 may comprise one or more sensors 325. The sensor(s) 325 may comprise, for example, one or more accelerometers, gyroscopes, magnetometers, altimeters, proximity sensors, light sensors, and the like. In some embodiments, the sensor(s) 325 may comprise an IMU. Sensor(s) 325 may be utilized, for example, to provide orientation and/or movement information regarding the launch module or vehicle of the rocket/missile artillery unit 120 (depending on the location of the sensor(s) 325 with regard to the rocket/missile artillery unit 120) and as such, may functionally replace the launch module orientation sensor 180-1 or vehicle orientation sensor 180-2. Additionally or alternatively, sensor(s) 325 may provide information for dead reckoning and/or other location determination techniques, which may be used to complement wireless positioning performed using data from Global Navigation Satellite System (GNSS) receiver 335 and/or wireless communication interface 340.

According to some embodiments, the military communications unit 150 may comprise a GNSS receiver 335 capable of receiving signals from one or more GNSS satellites using a GNSS antenna 336, and determining a location of the rocket/missile artillery unit 120. The GNSS receiver 335 may support measurement of signals from satellites of a GNSS system, such as Global Positioning System (GPS), Galileo, GLONASS, Quasi-Zenith Satellite System (QZSS), Indian Regional Navigational Satellite System (IRNSS) and/or other Satellite Positioning Systems (SPSes). Ultimately, the GNSS receiver 335 may determine a position of the rocket/missile artillery unit 120 using any combination of one or more global and/or regional navigation satellite systems, augmentation systems, and/or other positioning/navigation systems.

The military communications unit 150 may also include a wireless communication interface 340, which may comprise any number of hardware and/or software components for wireless communication. Such components may include, for example, a modem, a network card, an infrared communication device, a wireless communication device, and/or a chipset (e.g., components supporting Bluetooth, IEEE 802.11 (including Wi-Fi), IEEE 802.15.4 (including Zigbee), WiMAX™, cellular communication, etc.), and/or the like, which may enable the military communications unit 150 to wirelessly communicate with the various components illustrated in FIG. 2 and/or may enable the TES ARMOSS 200 to communicate with other entities within the TES environment 100. To enable this functionality, the wireless communication interface 340 may comprise various transceivers, and may communicate using commercial cellular and/or traditional military frequency bands, using one or more wireless RF technologies.

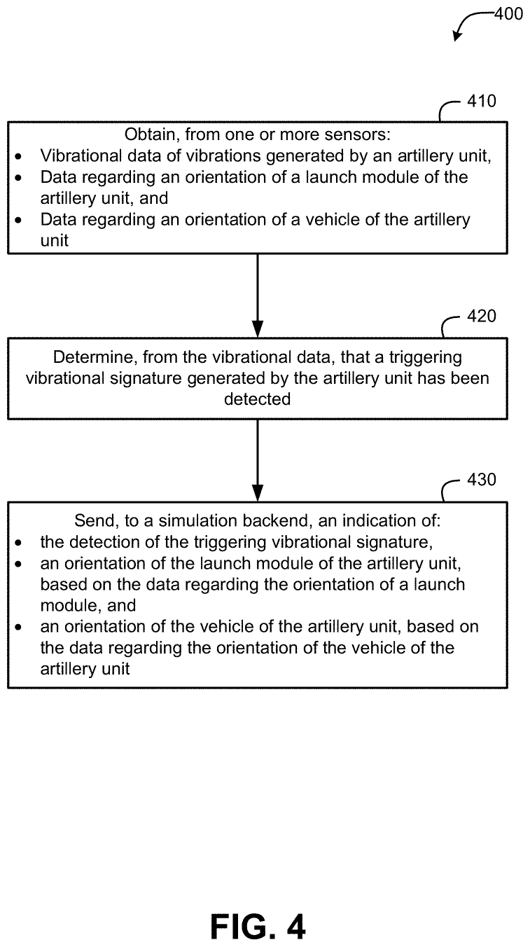

FIG. 4 is a flow diagram of a method 400 of performing artillery unit simulation, according to an embodiment. Alternative embodiments may vary in function by combining, separating, or otherwise varying the functionality described in the blocks illustrated in FIG. 4. Means for performing the functionality of one or more of the blocks illustrated in FIG. 4 may comprise one or more components of a military communications unit (or similar device), such as components of the embodiment of the military communications unit 150 illustrated in FIG. 3. Such means may further include software means, which may be executed by one or more processing units (e.g., processing unit(s) 310 of FIG. 3).

At block 410, the method comprises obtaining, from one or more sensors, vibrational data of vibrations generated by an artillery unit, data regarding an orientation of a launch module of the artillery unit, and data regarding an orientation of a vehicle of the artillery unit. As noted above, the artillery unit may comprise a rocket or missile artillery unit. In some embodiments, as illustrated in FIGS. 1-3, the sensors may be external to a military communications unit. However, in some embodiments, one or more of the sensors may be incorporated into the military communications unit. In some embodiments, the sensor data may be obtained via a communications interface, including a wireless communications interface (e.g., via Wi-Fi, Bluetooth, etc.).

At block 420, the functionality comprises determining, from the vibrational data, that a triggering vibrational signature generated by the artillery unit has been detected. As previously noted, this can involve frequency processing, such as applying one or more filters to vibrational data captured by a microphone, piezoelectric sensor, or similar vibration sensor. In some embodiments, such filtering can be conducted using analog and/or digital means. Additionally, as noted, such filtering may take place at the vibration sensor, and/or may take place at the military communications unit. That is, in some embodiments, the vibrational data may be received from a vibration sensor, and determining the triggering vibrational signature generated by the artillery unit has been detected may comprise detecting the triggering vibrational signature generated by the artillery unit from the vibrational data from the vibration sensor. Additionally or alternatively, determining that the triggering vibrational signature generated by the artillery unit has been detected may comprise receiving, in the vibrational data itself, an indication that the triggering vibrational signature generated by the artillery unit has been detected by the vibration sensor. Thus, the vibrational data may comprise raw vibration sensor data, or may comprise data derivative of the raw vibration sensor data, depending on desired functionality

At block 430, the functionality of the method 400 comprises sending, to a simulation backend, an indication of the detection of the triggering vibrational signature, and orientation of the launch module of the artillery unit, based on the data regarding the orientation of a launch module, and an orientation of the vehicle of the artillery unit, based on the data regarding the orientation of the vehicle of their artillery unit. In some embodiments, this may be sent via a wireless communication interface of the military communications unit. As noted, orientation of the launch module and/or vehicle of the artillery unit may be sent separately from detection of the vibrational signature. Thus, in some embodiments, one or both of these indications may be sent based on a predetermined schedule. Additionally or alternatively, these indications may be sent in response to determining that the triggering vibrational signature generated by the artillery unit has been detected.

Various components may be described herein as being “configured” to perform various operations. Those skilled in the art will recognize that, depending on implementation, such configuration can be accomplished through design, setup, placement, interconnection, and/or programming of the particular components and that, again depending on implementation, a configured component might or might not be reconfigurable for a different operation. Moreover, for many functions described herein, specific means have also been described as being capable of performing such functions. It can be understood, however, that functionality is not limited to the means disclosed. A person of ordinary skill in the art will appreciate that alternative means for performing similar functions may additionally or alternatively be used to those means described herein.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that may comprise memory may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. An artillery unit simulation system comprising:
a vibration sensor configured to gather vibrational data of vibrations generated by an artillery unit;
a launch module orientation sensor configured to obtain data regarding an orientation of a launch module of the artillery unit;
a vehicle orientation sensor configured to obtain data regarding an orientation of a vehicle of the artillery unit; and
a military communications unit configured to communicate wirelessly to a simulation backend and communicatively coupled with the vibration sensor, the launch module orientation sensor, and the vehicle orientation sensor, wherein the military communications unit is configured to:
determine, from the vibrational data gathered by the vibration sensor, that a triggering vibrational signature generated by the artillery unit has been detected; and
send, to the simulation backend, an indication of:
the detection of the triggering vibrational signature;
an orientation of the launch module of the artillery unit, based on the data obtained by the launch module orientation sensor; and
an orientation of the vehicle of the artillery unit, based on the data obtained by the vehicle orientation sensor.

2. The artillery unit simulation system of claim 1, wherein the artillery unit comprises a rocket or missile artillery unit.

3. The artillery unit simulation system of claim 1, wherein the vibration sensor comprises a microphone, a piezoelectric sensor, or a combination thereof.

4. The artillery unit simulation system of claim 1, wherein the military communications unit is further configured to:
receive the vibrational data from the vibration sensor; and
detect the triggering vibrational signature generated by the artillery unit from the vibrational data gathered by the vibration sensor.

5. The artillery unit simulation system of claim 1, wherein the vibration sensor is further configured to:
detect the triggering vibrational signature generated by the artillery unit from the vibrational data; and
provide an indication of the detection to the military communications unit.

6. The artillery unit simulation system of claim 1, wherein the military communications unit is configured to send the indication of the orientation of the launch module of the artillery unit, the indication of the orientation of the vehicle of the artillery unit, or both, in response to determining that the triggering vibrational signature generated by the artillery unit has been detected.

7. The artillery unit simulation system of claim 1, wherein the military communications unit is configured to send the indication of the orientation of the launch module of the artillery unit, the indication of the orientation of the vehicle of the artillery unit, or both, based on a predetermined schedule.

8. A method of performing artillery unit simulation, the method comprising:
obtaining, from one or more sensors:
vibrational data of vibrations generated by an artillery unit;
data regarding an orientation of a launch module of the artillery unit; and
data regarding an orientation of a vehicle of the artillery unit;
determining, from the vibrational data, that a triggering vibrational signature generated by the artillery unit has been detected; and
sending, to a simulation backend, an indication of:
the detection of the triggering vibrational signature;
an orientation of the launch module of the artillery unit, based on the data regarding the orientation of a launch module; and
an orientation of the vehicle of the artillery unit, based on the data regarding the orientation of the vehicle of the artillery unit.

9. The method of claim 8, wherein the artillery unit comprises a rocket or missile artillery unit.

10. The method of claim 8, further comprising receiving the vibrational data from a vibration sensor, wherein determining that the triggering vibrational signature generated by the artillery unit has been detected comprises detecting the triggering vibrational signature generated by the artillery unit from the vibrational data from the vibration sensor.

11. The method of claim 8, further comprising receiving the vibrational data from a vibration sensor, wherein determining that the triggering vibrational signature generated by the artillery unit has been detected comprises receiving, in the vibrational data, an indication that the triggering vibrational signature generated by the artillery unit has been detected by the vibration sensor.

12. The method of claim 8, wherein sending the indication of the orientation of the launch module of the artillery unit, the indication of the orientation of the vehicle of the artillery unit, or both, is in response to determining that the triggering vibrational signature generated by the artillery unit has been detected.

13. The method of claim 8, wherein sending the indication of the orientation of the launch module of the artillery unit, the indication of the orientation of the vehicle of the artillery unit, or both, is based on a predetermined schedule.

14. A device for performing artillery unit simulation, the device comprising:
a communication interface;
a memory; and
a processing unit communicatively coupled with the memory and the communication interface and configured to cause the device to:
obtain, from one or more sensors:
vibrational data of vibrations generated by an artillery unit;
data regarding an orientation of a launch module of the artillery unit; and
data regarding an orientation of a vehicle of the artillery unit;
determine, from the vibrational data, that a triggering vibrational signature generated by the artillery unit has been detected; and
send, to a simulation backend, an indication of:
the detection of the triggering vibrational signature;
an orientation of the launch module of the artillery unit, based on the data regarding the orientation of a launch module; and
an orientation of the vehicle of the artillery unit, based on the data regarding the orientation of the vehicle of the artillery unit.

15. The device of claim 14, wherein the processing unit is configured to obtain the vibrational data, the data regarding the orientation of the launch module, the data regarding the orientation of the vehicle, or any combination thereof, via the communication interface.

16. The device of claim 14, wherein the communication interface comprises a wireless communication interface.

17. The device of claim 14, wherein:
the processing unit is configured to cause the device to obtain the vibrational data at least in part by receiving the vibrational data from a vibration sensor, and
wherein the processing unit is configured to cause the device to determine that the triggering vibrational signature generated by the artillery unit has been detected at least in part by detecting the triggering vibrational signature generated by the artillery unit from the vibrational data from the vibration sensor.

18. The device of claim 14, wherein:
the processing unit is configured to cause the device to obtain the vibrational data at least in part by receiving the vibrational data from a vibration sensor, and
wherein the processing unit is configured to cause the device to determine that the triggering vibrational signature generated by the artillery unit has been detected at least in part by receiving, in the vibrational data, an indication that the triggering vibrational signature generated by the artillery unit has been detected by the vibration sensor.

19. The device of claim 14, the processing unit is configured to cause the device to send the indication of the orientation of the launch module of the artillery unit, the indication of the orientation of the vehicle of the artillery unit, or both, in response to determining that the triggering vibrational signature generated by the artillery unit has been detected.

20. The device of claim 14, the processing unit is configured to cause the device to send the indication of the orientation of the launch module of the artillery unit, the indication of the orientation of the vehicle of the artillery unit, or both, based on a predetermined schedule.
